(19) United States
(12) Patent Application Publication
(10) Pub. No.: US 2021/0068078 A1
(43) Pub. Date: Mar. 4, 2021

(54) Devices And Methods For Sidelink Resource Pool Selection Based On Physical Motion

(71) Applicant: HUAWEI TECHNOLOGIES CO., LTD., Shenzhen (CN)

(72) Inventors: Daniel MEDINA, Munich (DE); Serkan AYAZ, Munich (DE)

(21) Appl. No.: 17/021,863

(22) Filed: Sep. 15, 2020

Related U.S. Application Data
(63) Continuation of application No. PCT/EP2018/056703, filed on Mar. 16, 2018.

(51) Int. Cl. H04W 72/02; H04W 72/04; H04W 4/02; H04W 24/10

(52) U.S. Cl. CPC H04W 72/02; H04W 72/048; H04W 92/18; H04W 24/10; H04W 4/027

(57) ABSTRACT

This application provides a sidelink communication device, a network management entity, and methods for sidelink resource pool selection. The sidelink communication device selects a radio resource pool from a plurality of radio resource pools on the basis of a physical motion parameter of the sidelink communication device. The sidelink communication device also communicates with another sidelink communication device using one or more radio resources of the selected radio resource pool. The network management entity generates radio resource pool configuration information. The radio resource pool configuration information comprises a correspondence of one or more possible physical motion parameters to one or more radio resource pools or a correspondence of one or more flow identities to one or more radio resource pools. The network management entity also transmits the radio resource pool configuration information to one or more sidelink communication devices.

### CROSS-REFERENCE TO RELATED APPLICATIONS

This application is a continuation of International Application No. PCT/EP2018/056703, tiled on Mar. 16, 2018, the disclosure of which is hereby incorporated by reference in its entirety.

### TECHNICAL FIELD

In general, the present invention relates to the field of wireless communication. More specifically, the present invention relates to devices and methods for sidelink resource pool selection, in particular a sidelink communication device, a network management entity as well as corresponding methods.

### BACKGROUND

In 3^{rd} Generation Partnership Project (3GPP) networks, Vehicle-to-Everything (V2X) services can be provided directly via a so-called PC5 interface (also known as sidelink or Device-to-Device (D2D) communication) and/or indirectly via an LTE-Uu interface (also known as uplink/downlink), as specified in 3GPP TS 36.300 V14.2.0, “LTE; Evolved Universal Terrestrial Radio Access (E-UTRA) and Evolved Universal Terrestrial Radio Access Network (E-UTRAN); Overall description; Stage 2”. Support of V2X services via the PC5 interface is provided by V2X sidelink communication, which is a communication mode in which User Equipments (UEs) such as vehicles can communicate with each other directly via the PC5 interface. This communication mode is supported when the UE is served by E-UTRAN and when the UE is outside of E-UTRA coverage.

A UE supporting V2X sidelink communication can operate in two modes for sidelink radio resource allocation:
In scheduled resource allocation, which is a centralized approach, the UE requests transmission radio resources from a base station (BS) and the base station (BS) allocates dedicated transmission radio resources to the UE.
In UE autonomous resource selection, which is a distributed approach, the UE, on its own, selects radio resources from (pre)configured resource pools,

This invention relates specifically to the UE autonomous resource selection mode, which is also referred to as sidelink transmission mode 4 in 3GPP specifications.

In order to prevent interference among V2X sidelink transmissions in mode 4, 3GPP Radio Resource Control (RRC) specifications, as outlined in standard 3GPP TS 36.331 V14.1.0, comprise two features in Release 14.

First, the world is divided into geographical zones. A zone is a periodically repeating geographical region. The UE selects a radio resource pool based on the zone it is located in.

Second, the UE employs sensing. Based on channel sensing—in particular, sensing of a parameter known as Sidelink Received Signal Strength Indicator (S-RSSI)—within the selected radio resource pool, the UE selects specific sidelink radio resources for transmission.

One of the main goals in radio resource selection is to select a radio resource that will remain free of interference from other UEs for a certain reselection period. In sidelink transmission mode 4, the UE may select and/or reselect Physical Sidelink Shared Channel (PSSCH) resources autonomously based on channel sensing. Once a resource is selected, a reselection period is started, after which a reselection of resources may be triggered. At the end of each reselection period, the UE keeps the previously selected resource with a probability probResourceKeep.

If the UE does not keep the previously selected resource, the UE selects the number of retransmissions (0 or 1) as configured in a parameter allowedRetxNumberPSSCH. It then selects an amount of frequency resources (e.g., contiguous subchannels) within a configurable range, in particular between minRB-NumberPSSCH and maxRB-NumberPSSCH. The UE then sets a resource reservation interval parameter to one of the allowed values configured in restrictResourceReservationPeriod. Finally, the UE randomly selects a resource and uses it to select a set of periodic resources spaced by the resource reservation interval.

A candidate resource is defined as a set of L_{subCH} contiguous subchannels in a given subframe. Any set of L_{subCH} contiguous subchannels in the PSSCH resource pool within a certain time window corresponds to a candidate resource. The UE excludes resources for which either it has no measurement information or which are reserved by nearby UEs with an associated PSSCH Reference Signal Received Power (PSSCH-RSRP) above a certain (priority-dependent) threshold. From the remaining candidate resources, the physical (PHY) layer reports to the Medium Access Control (MAC) layer only a subset of resources, namely those with the lowest S-RSSI values. The MAC layer then selects randomly among the reported resources.

According to the above-mentioned standards, each radio resource pool is configured with a zoneID identifying a zone in which the resource pool may be used. Based on its location (x, y), a UE (e.g. a sidelink communication device) wishing to use a radio resource derives the identity of the zone it is located in as follows:

$$zoneID = {v}_{2} {N}_{x} + {v}_{1}$$

$$where$$

$${v}_{1} = ⌊ \frac{x}{L} ⌋ mod {N}_{x}$$

$${v}_{2} = ⌊ \frac{y}{W} ⌋ mod {N}_{y}$$

and
x distance in longitude between UE's current location and geographical coordinates (0,0)
y distance in latitude between UE's current location and geographical coordinates (0,0)

The UE then selects a radio resource pool configured with the corresponding zoneID.

The following parameters are configured by the network operator or pre-configured in the UE (zoneConfig):
L zone length (zoneLength)
W zone width (zoneWidth)
Nₓ reuse distance with respect to longitude (zoneldLongiMod)
N_{y} reuse distance with respect to latitude (zoneldLatiMod)

The allocation of a radio resource pool according to location as defined in the above-mentioned standards, however, has drawbacks that motivate the present invention. First of all, dividing the world into zones very often does not match the geometry of streets. Thus, unpredictable interference may be caused by hidden terminals within a zone. For example, multiple terminals may be converging at an intersection. These terminals all draw from the same radio resource pool as they are all located in the same zone. Coming from different directions and also being possibly out of reach of each other's radios when the resource selection happens, they might choose identical resources. When they converge on the intersection, they will then start interfering with each other.

Also, creating evenly distributed zones does not take into account the traffic demand and therefore the need for radio resources at certain locations. For example, dense areas such as a big intersection in the city center may require more radio resources than sparsely populated areas such as a suburban residential street. Accordingly, resource pools might be overcrowded at some locations and underutilized at others.

### SUMMARY

It is an objective of the present invention to provide a sidelink communication device, a method for operating a sidelink communication device, a network management entity and a method for allocating radio resources to a sidelink communication device as well as a computer program that improve radio resource selection and/or allocation by making interference with other sidelink communication devices less likely.

A first aspect of the invention provides a sidelink communication device comprising a processor configured to select a radio resource pool from a plurality of radio resource pools on the basis of a physical motion parameter of the sidelink communication device and a communication interface configured to communicate with another sidelink communication device using one or more radio resources of the selected radio resource pool.

In this way, sidelink communication devices having similar physical motion parameters select the same radio resource pool. This increases accuracy when predicting which radio resources will be occupied in the near future, e.g., in the next few seconds. Objects moving in a different direction or at very different speed are less likely to interfere with the radio communication of the sidelink communication device as they use a different radio resource pool.

In a further implementation of the first aspect, the sidelink communication device is configured to measure the physical motion parameter, receive the physical motion parameter from another sidelink communication device and/or a network management entity, derive the physical motion parameter on the basis of information measured on its own and/or derive the physical motion parameter on the basis of information received from another sidelink communication device and/or a network management entity.

In this way, the sidelink communication device selects the radio resource pool based on accurate physical motion parameters that are easy to obtain.

In a further implementation of the first aspect, the physical motion parameter is based on a velocity vector, in particular a magnitude and/or a direction of a velocity vector, of the sidelink communication device in a given frame of reference.

Velocity vectors are fairly easy to obtain in an accurate manner and provide a good measure of how the sidelink communication device moves and which other sidelink communication devices will stay close to it in the near future.

In a further implementation of the first aspect, the physical motion parameter is an index pointing to an element of a lookup table, wherein the element corresponds to a possible velocity vector of the sidelink communication device in a given frame of reference.

Instead of providing a complicated and long list of detailed velocity vectors, the physical motion parameter may be processed and thus reduced to the necessary information for selecting a radio resource pool. In this way, the amount of data to be transmitted is reduced.

In a further implementation of the first aspect, the processor is configured to select the radio resource pool on the basis of radio resource pool configuration information, wherein the radio resource pool configuration information comprises a correspondence of one or more possible physical motion parameters to one or more radio resource pools.

In a further implementation of the first aspect, the processor is configured to determine a flow identity on the basis of the physical motion parameter and on the basis of flow configuration information, wherein the flow configuration information comprises a correspondence of one or more possible physical motion parameters to one or more flow identities.

In a further implementation of the first aspect, the processor is configured to select the radio resource pool on the basis of the determined flow identity and on the basis of radio resource pool configuration information, wherein the radio resource pool configuration information comprises a correspondence of one or more flow identities to one or more radio resource pools.

In a further implementation of the first aspect, the communication interface is configured to receive the flow configuration information and/or the radio resource pool configuration information from a network management entity.

The flow configuration information and/or the radio resource pool configuration information thus becomes easily distributable.

In a further implementation of the first aspect, the sidelink communication device comprises at least one of the following: preconfigured flow configuration information, comprising a correspondence of one or more possible physical motion parameters to one or more flow identities; preconfigured radio resource pool configuration information, comprising a correspondence of one or more flow identities to one or more radio resource pools; and/or preconfigured radio resource pool configuration information, comprising a correspondence of one or more possible physical motion parameters to one or more radio resource pools.

Thus, handling of information regarding radio resource pools and physical motion parameters is simplified

In a further implementation of the first aspect, the processor is configured to select the radio resource pool on the basis of a measurement of the observed traffic load in one or more radio resource pools, in particular a channel busy ratio (CBR) measurement, performed by the sidelink communication device.

Radio resource pools that are very busy and thus prone to interference can be avoided in this way.

A second aspect of the invention provides a method for operating a sidelink communication device comprising the steps of selecting a radio resource pool from a plurality of radio resource pools on the basis of a physical motion parameter of the sidelink communication device and communicating with another sidelink communication device using one or more radio resources of the selected radio resource pool.

In this way, sidelink communication devices having similar physical motion parameters select the same radio resource pool. This increases accuracy when predicting which radio resources will be occupied in the near future, e.g., in the next few seconds. Objects moving in a different direction or at a very different speed are less likely to interfere with the radio communication of the sidelink communication device as they use a different radio resource pool.

In a further implementation of the second aspect, the method comprises determining a flow identity on the basis of the physical motion parameter of the sidelink communication device and selecting the radio resource pool on the basis of the determined flow identity.

In a further implementation of the second aspect, the physical motion parameter is based on a velocity vector, in particular a magnitude and/or a direction of a velocity vector, of the sidelink communication device in a given frame of reference.

A third aspect of the invention provides a network management entity, in particular a base station, a core network management entity or a cloud server, comprising a processor configured to generate radio resource pool configuration information, wherein the radio resource pool configuration information comprises a correspondence of one or more possible physical motion parameters to one or more radio resource pools and/or a correspondence of one or more flow identities to one or more radio resource pools, and a communication interface configured to transmit the radio resource pool configuration information to one or more sidelink communication devices.

In a further implementation of the third aspect, the correspondence is determined on the basis of a measurement of the observed traffic load in one or more radio resource pools, in particular a channel busy ratio (CBR) measurement, performed by one or more sidelink communication devices.

A previously determined correspondence can be adapted based on CBR information. In particular, radio resource pools assigned to flow identities can be adapted to the degree of utilization of the assigned radio resource pools. If, for example, a certain radio resource pool is not sufficiently used, it can be reduced and the freed resources can be assigned to flow identities that have higher demand. In this way, spectral efficiency can be maximized.

In a further implementation of the third aspect, the processor is configured to generate flow configuration information, wherein the flow configuration information comprises a correspondence of one or more possible physical motion parameters to one or more flow identities and wherein the communication interface is configured to transmit the flow configuration information to one or more sidelink communication devices.

In a further implementation of the third aspect, at least one of the possible physical motion parameters is based on a velocity vector, in particular a magnitude and/or a direction of a velocity vector, in a given frame of reference.

In a further implementation of the third aspect, the processor is configured to derive one or more of the possible physical motion parameters from one or more position reports received from one or more sidelink communication devices.

In a further implementation of the third aspect, the processor is configured to generate the radio resource pool configuration information on the basis of one or more of the following: a number of sidelink communication devices associated with a flow identity and/or physical motion parameter; a measurement of the traffic demand of one or more sidelink communication devices associated with a flow identity and/or physical motion parameter.

A fourth aspect of the invention provides a method for allocating radio resources to a sidelink communication device, the method comprising the steps of generating radio resource pool configuration information, wherein the radio resource pool configuration information comprises a correspondence of one or more possible physical motion parameters to one or more radio resource pools and/or a correspondence of one or more flow identities to one or more radio resource pools, and transmitting the radio resource pool configuration information to the sidelink communication device.

In a further implementation of the fourth aspect, the method comprises generating flow configuration information, wherein the flow configuration information comprises a correspondence of one or more possible physical motion parameters to one or more flow identities, and transmitting the flow configuration information to the sidelink communication device.

A fifth aspect of the invention provides a computer program which, when executed on a computer, causes the computer to implement a device as described above or to carry out a method as described above.

It should be noted that the above apparatuses may be implemented based on a discrete hardware circuitry with discrete hardware components, integrated chips or arrangements of chip modules, or based on a signal processing device or chip controlled by a software routine or program stored in a memory, written on a computer-readable medium or downloaded from a network such as the internet.

It shall further be understood that a preferred embodiment of the invention can also be any combination of the dependent claims or above embodiments with the respective independent claim.

These and other aspects of the invention will be apparent from the embodiments described below.

### BRIEF DESCRIPTION OF THE DRAWINGS

To illustrate the technical features of embodiments of the present invention more clearly, the accompanying drawings provided for describing the embodiments are introduced briefly in the following. The accompanying drawings in the following description are merely some embodiments of the present invention, but modifications of these embodiments are possible without departing from the scope of the present invention as defined in the claims.

FIG. 1 shows a bird's-eye view of a scenario in which multiple sidelink communication devices are moving as a general introduction to the present invention;

FIG. 2 shows a schematic view of communication pathways in a wireless network;

FIG. 3 shows a schematic modular view of a sidelink communication device according to an embodiment of the present invention;

FIG. 4 shows a schematic view of an example for a definition of physical motion parameters employable in an embodiment according to the present invention;

FIG. 5 shows another schematic view of an example for a definition of physical motion parameters employable in an embodiment according to the present invention;

FIG. 6 shows a diagram for modeling a simulation of embodiments of the present invention;

FIG. 7 shows a diagram for modeling relative velocity in a simulation according to FIG. 6 and

FIG. 8 shows a diagram with possible results of the simulation.

### DETAILED DESCRIPTION

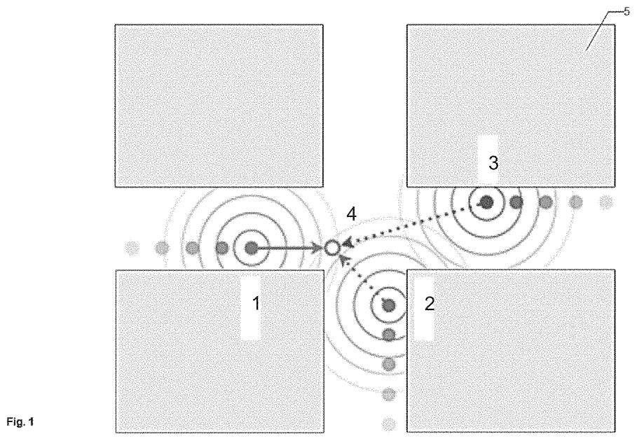

General aspects of sidelink communication devices 1, 2, 3 when employing UE autonomous resource selection are shown in FIG. 1. The sidelink communication devices 1, 2, 3 are comprised in vehicles moving as indicated by a trace of dots. Based on sensing, each of the sidelink communication devices 1, 2, 3 selects a radio resource which seems to be unused and will use that radio resource in the near future, e.g., for the next few seconds.

Due to buildings 5, the sidelink communication devices 1 and 2 can, at the moment shown, not receive each other's signals. As a result, a radio resource being used by sidelink communication device 2 may seem unused and may be selected by sidelink communication device 1 for transmission to sidelink communication device 4. Sidelink communication device 4, located at the intersection, may thus be exposed to unexpected interference from sidelink communication device 2. Furthermore, the sidelink communication devices 1 and 3 are too far away from each other to be able to detect each other's transmissions. Therefore, the sidelink communication devices 1 and 3 may, when they both converge on the intersection, use interfering radio resources.

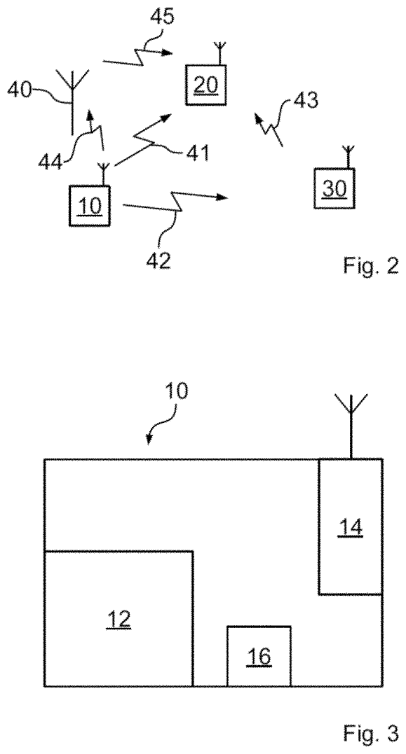

FIG. 2 shows the general wireless network structure employed for sidelink communication devices 10, 20, 30 which are generally similar to the sidelink communication devices 1, 2, 3. Sidelink communication devices 10, 20, 30 may communicate with each other for example via wireless links 41, 42, 43. Furthermore, the sidelink communication devices 10, 20, 30 may communicate with a network management entity 40 via wireless links 44, 45. Although the wireless links 41, 42, 43, 44, 45 are shown as unidirectional, they may of course be bidirectional or even broadcast links.

A network management entity 40 may be any entity higher than the sidelink communications devices 10, 20, 30 within the hierarchy of the wireless network used. The sidelink communication devices 10, 20, 30 may be peers, i.e. devices on the same level of the hierarchy.

The sidelink communication device 10, which is substantially identical to the sidelink communication devices 20 and 30, is shown in FIG. 3. The sidelink communication device 10 comprises a processor 12 as well as a communication interface 14. The processor 12 and the communication interface 14 are connected within the sidelink communication device 10 by means that are not shown in FIG. 3. The sidelink communication device 10 further comprises a physical motion detection device 16 which may be connected to the processor 12 and/or the communication interface 14. The physical motion detection device 16 may also be located at a distance from the processor 12 and/or the communication interface 14 and may only be connected to those devices wirelessly.

The processor 12 controls aspects of the communication interface 14. In particular, the processor 12 controls which radio resources and/or radio resource pools the communication interface 14 uses for communication with other sidelink communication devices 20, 30.

To this end, the sidelink communication device 10 may determine a physical motion parameter, in particular of itself. This determination of the physical motion parameter may be carried out, by measuring the physical motion parameter, by receiving the physical motion parameter from somewhere outside the sidelink communication device 10 or by deriving the physical motion parameter based on information measured on its own and/or based on information received from somewhere outside the sidelink communication device 10.

In one embodiment, the sidelink communication device 10, by means of, e.g., the physical motion detection device 16, may directly measure the physical motion parameter. The physical motion parameter measured may be based on a velocity vector, in particular a magnitude and/or a direction of a velocity vector in a given frame of reference. As an example, the physical motion parameter may be measured as the direction and magnitude of the velocity of the sidelink communication device 10 relative to the ground. As a further example, in particular related to automotive applications, the physical motion parameter may comprise a heading of a vehicle and a speed of the vehicle.

In another embodiment, the sidelink communication device 10, by means of, e.g., the physical motion parameter detection device 16, may measure some information related to the sidelink communication device 10 and derive the physical motion parameter based on this information. In this case, the sidelink communication device 10 may, for example, measure acceleration and rotation of the sidelink communication device 10 by means of an accelerometer and/or a gyroscope. The accelerometer and/or the gyroscope may be comprised in the physical motion detection device 16.

In yet another embodiment, the sidelink communication device 10 may receive the physical motion parameter via the communication interface 14 from one of the other sidelink communication devices 20, 30 or from the network management entity 40. In another embodiment, the sidelink communication device 10 may receive information via the communication interface 14 from another sidelink communication device 20, 30 or from the network management entity 40, and derive the physical motion parameter from this information.

The information received from another sidelink communication device 20, 30 or from the network management entity 40 may comprise one or a variety of measurements, e.g., distance, distance from a certain reference point, acceleration, directional measurements or any other kind of measurement usable for determining a physical motion parameter of the sidelink communication device 10.

The sidelink communication device 10 may comprise a lookup table with a multitude of elements. Each element corresponds to a possible velocity vector of the sidelink communication device 10 in a given frame of reference. These elements are indexed, so that if an index is known, the corresponding physical motion parameter can be retrieved from the lookup table. When such a lookup table is present, the physical motion parameter may be expressed as an index into the lookup table.

To determine which radio resources the communication interface 14 may use, the processor 12 is configured to select a radio resource pool from a plurality of radio resource pools on the basis of the physical motion parameter.

To this end, radio resource pool configuration information may be provided which comprises a correspondence of one or more possible physical motion parameters to one or more radio resource pools. The processor 12 is then configured to use the physical motion parameter to select a radio resource pool according to the respective correspondence in the radio resource pool configuration information. The correspondence may be provided by way of, for example, a table comprising, in each line, information related to a physical motion parameter, e.g., a direction and/or magnitude of a velocity vector, and information identifying a radio resource pool.

In another embodiment, the radio resource pool configuration information may comprise a correspondence of one or more flow identities to one or more radio resource pools. Flow identities may be represented by a flow identification which may, for example, be an integer. Furthermore, the processor 12 may be configured to determine the flow identity on the basis of the physical motion parameter and on the basis of flow configuration information. The flow configuration information may comprise a correspondence of one or more possible physical motion parameters to one or more flow identities. In this way, the actual possible physical motion parameters used to determine which radio resource pool is to be used are decoupled from the actual radio resource pools. This reduces the amount of data that needs to be exchanged or updated when the possible physical motion parameters change.

The communication interface 14 may be configured to receive the flow configuration information and/or the radio resource pool configuration information from a network management entity.

It is also possible for the sidelink communication device 10 to comprise preconfigured flow configuration information and/or preconfigured radio resource pool configuration information.

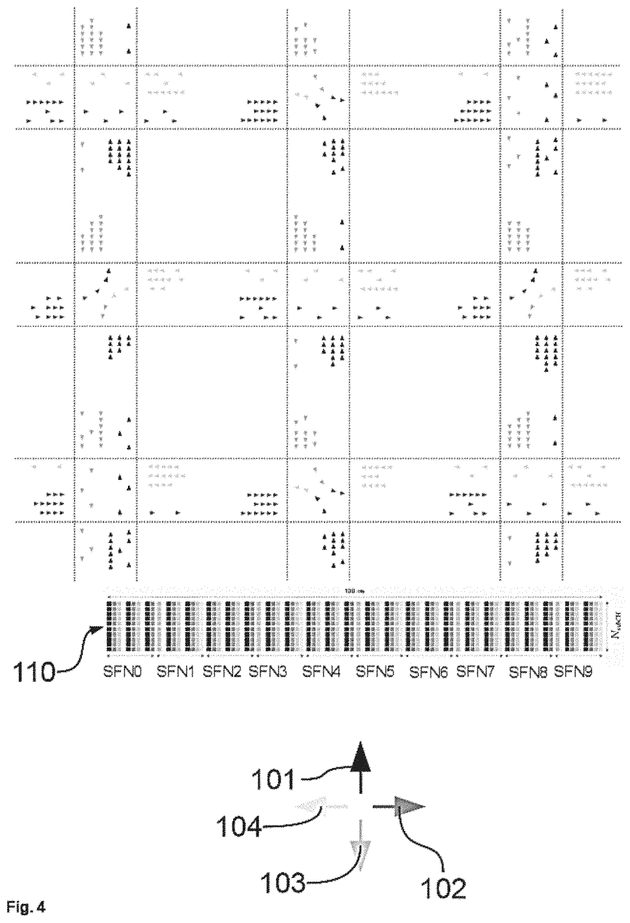

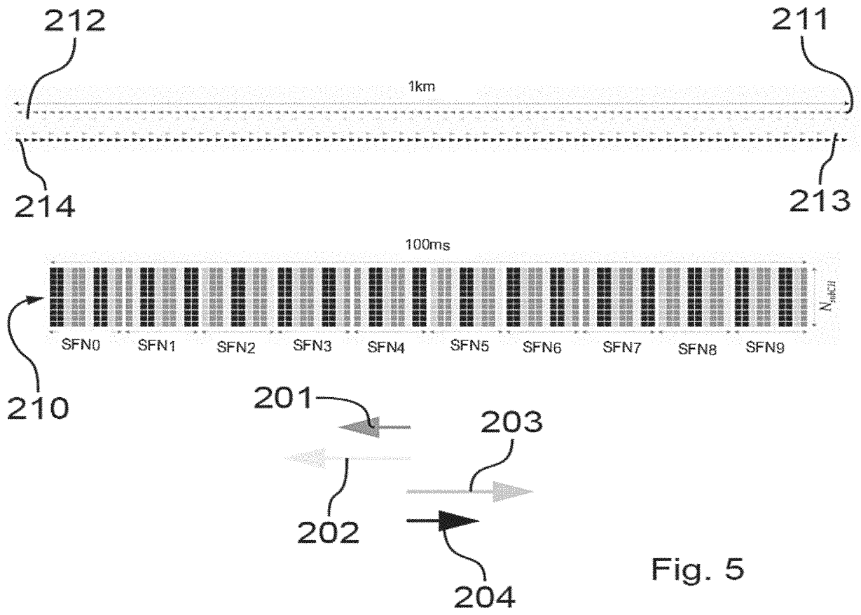

As examples for the above, two scenarios are shown in FIGS. 4 and 5.

The urban scenario shown in FIG. 4 uses a rectangular street layout to make vehicles going in the same direction utilize the same radio resource pool.

As shown in FIG. 4, orthogonal radio resource pools correspond to crossing streets, thus addressing the intersection scenario, i.e., terminals hidden by buildings as described in FIG. 1. In this example, the network configures four possible physical motion parameters represented as directional arrows 101, 102, 103, and 104 and corresponding to North, East, South, and West, and associates these with separate flows.

Orthogonal radio resource pools are associated with each flow. The orthogonal radio resource pools, in the present example, are separate subframes, each associated with one of the flows. Thus, in the center FIG. 110 of FIG. 4, the sequence of utilization of the radio resource pools is shown over time, in particular over system frame numbers SFN 0 to SFN 9, as an example.

Vehicles, represented as triangles pointing in their direction of travel, are associated with one of the possible physical motion parameters 101, 102, 103, 104 which corresponds to the closest to their direction of travel. Thus, all northbound vehicles share a common radio resource pool, as do all eastbound, westbound and southbound vehicles, respectively. The vehicles carry UEs comprising sidelink communication devices 10, 20, 30, which may each select radio resource pools for communication with each other. As all the vehicles sharing a common radio resource pool travel in the same direction, they tend to remain closer together in a short time frame. Accordingly, measurements of the channel, e.g., of a Sidelink Received Signal Strength Indicator (S-RSSI), tend to remain correct for a certain time frame after the measurement.

In a given geographical region, such as the coverage area of a cell, there will typically be only a small set of flows, each represented by the average velocity vector in the flow. Different geographical regions may have different flows and/or flow demands. Thus, they will in general need different radio resource pool configurations.

When the radio resource pool configuration is provided by the network, e.g., the network management entity 40 or a base station, the complete radio resource space can be partitioned according to the actual flows (velocity vectors) in a given geographical region and their demands. In the present example, the actual flows would correspond to the street layout and thus the main flow directions are perpendicular and bidirectional. These flow directions can be derived by the network from periodic UE position reports, as the network understands from these how UEs are moving.

When the radio resource pool configuration is preconfigured in the UE, the actual flows are not known in advance. In this case, the complete radio resource space can be partitioned according to the four nominal vectors corresponding to North, East, South, and West.

The highway scenario shown in FIG. 5 associates vehicles to a radio resource pool based on whether they move in the same direction and based on their speed.

In this example, the network configures 4 velocity vectors 201, 202, 203, 204 as slow lanes 211, 214 and fast lanes 212, 213 in each direction and allocates orthogonal radio resource pools (interleaved in time) to each flow. In order to prevent loss of spectral efficiency as a result of partitioning, i.e., due to pool underutilization, the radio resource pool size may be adjusted to the number of UEs in each flow and/or their current traffic demand. In the example, traffic in the slow lanes 211, 214 is denser. Thus, they are allocated larger radio resource pools. The network management entity 40 may detect the density of traffic having similar physical motion parameters or a comparable metric and adjust the allocation of radio resource pools accordingly. The traffic density may in particular be measured by measuring the CBR or by correlating all the physical motion parameters reported by individual sidelink communication devices 10, 20, 30.

Based on channel sensing within the selected radio resource pool which relies on stable channel measurements due to the low relative velocity within each radio resource pool—the UE selects specific sidelink radio resources for transmission. Because of the greater stability of the measurements, radio resources reserved based on their low S-RSSI at the time of radio resource selection are more likely to maintain their low S-RSSI values, thus increasing reliability.

If the UE cannot find a radio resource with an S-RSSI below a certain threshold (e.g., due to radio resource pool overload), the UE may select another radio resource pool corresponding to the closest physical motion parameter among the remaining flows. For example, if a vehicle on the fast lane cannot find a good resource within its radio resource pool, it may try first the radio resource pool corresponding to the slow lane on the same side of the highway, etc.

In a further example, each radio resource pool is configured with a flowID identifying the flow for which the radio resource pool may be used. Based on its velocity vector \vec{v}, the sidelink communication device 10, 20, 30 derives the identity of the flow it belongs to as follows:

$$flowID = f ( {\vec{u}}_{j} ) \vert j = {argmin}_{k} ‖ {\vec{u}}_{k} - \vec{v} ‖$$

where
\vec{u}ₖ kth configured velocity vector in the flow configuration information (flowConfig)
\vec{v} current velocity vector of the sidelink communication device 10, 20, 30
and f (·) is a function mapping each configured velocity vector \vec{u}ₖ to a flowlD. The flow configuration information (flowConfig), comprising a set of configured velocity vectors \vec{u}ₖ and a mapping f(·) to flow identities, may be provided by a network management entity 40 or preconfigured in the sidelink communication device 10, 20, 30. The sidelink communication device 10, 20, 30 then selects a radio resource pool configured with the corresponding flowID.

In order to quantify the performance gain that can be achieved by the proposed method, we define the probability

p=P(max_{0≤t≤T}s(t)<η|v)

i.e., the probability that the received signal strength (S-RSSI) s(t) in a selected/reserved resource will stay below a threshold value η within the resource reselection period T (where t=0 corresponds to the time of resource selection/reservation), given that the sensing UE is moving with velocity v.

Assuming free space propagation, the S-RSSI s(t) measured at a sensing UE at time t in a certain resource is given by

$$s ( t ) = {Σ}_{j ∈ A ( t )} \frac{κ}{{a}_{j}^{2} + {( {x}_{j} ( t ) )}^{2}} = {Σ}_{j ∈ A ( t )} \frac{κ}{{a}_{j}^{2} + {( {x}_{j} + Δ {v}_{j} \cdot t )}^{2}}$$

where
A(t) set of UEs transmitting on given resource at time t
k constant (depends on transmit power and carrier frequency
aⱼ transversal distance (i.e., perpendicular to the highway axis) between UE j and the sensing UE
xⱼ longitudinal distance (i.e., along the highway axis) between UE j and the sensing UE at t=0
Δvⱼ relative velocity of UE j with respect to the sensing UE

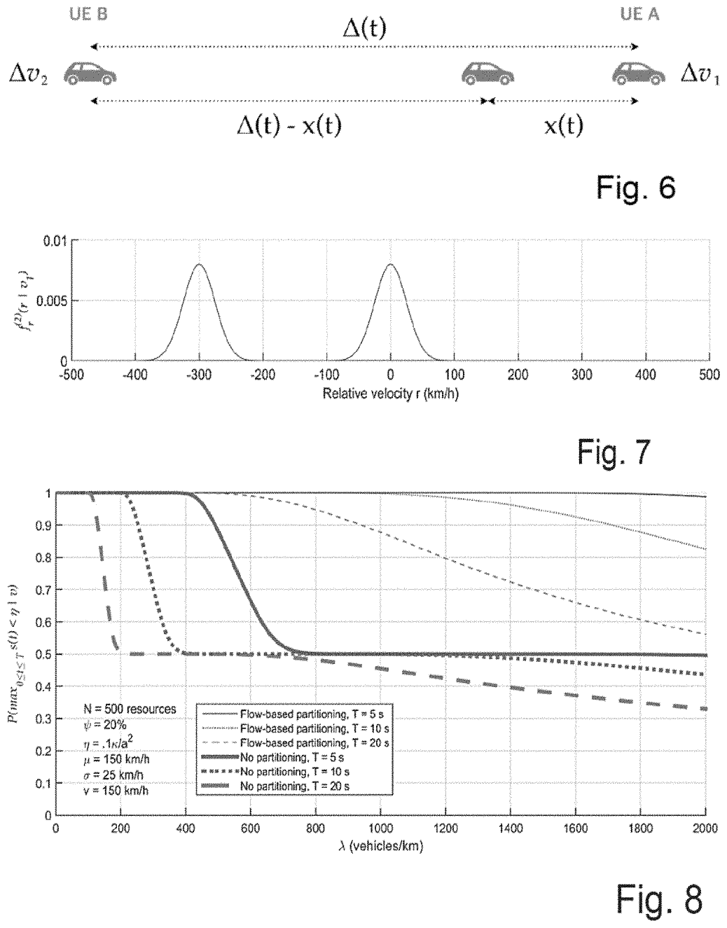

In what follows, and as shown in FIG. 6, we consider only the two closest UEs (A and B) in A(t) (i.e., we neglect the contributions from all other UEs, located further away), and make the following approximation

$$s ( t ) \approx κ ( \frac{1}{{a}^{2} + {( x ( t ) )}^{2}} + \frac{1}{{a}^{2} + {( Δ ( t ) - x ( t ) )}^{2}} )$$

where x(t)=x+Δv₁·t t is the longitudinal distance between UE A and the sensing UE at time t and Δ(t)=Δ+(Δv₁−Δv₂)t is the longitudinal distance between UE A and UE B at time t.

Given N candidate resources and a UE density λ UEs/km, assuming UEs are uniformly distributed over all N resources (as a result of resource selection choosing resources with lowest S-RSSI), the effective UE density in a given resource is λ/N UEs/km. Thus, the average distance between two UEs transmitting in a given resource is

Δ=N/λ

We model the relative velocity Δv as a random variable r with pdf given by

$${f}_{r}^{( 2 )} ( r \vert {v}_{1} ) = \frac{1}{\sqrt{2 {πσ}^{2}}} ( \frac{1}{2} {e}^{- \frac{{( r + {v}_{1} - μ )}^{2}}{2 {σ}^{2}}} + \frac{1}{2} {e}^{- \frac{{( r + {v}_{1} + μ )}^{2}}{2 {σ}^{2}}} )$$

where each term in the brackets corresponds to one side of the highway, as shown in FIG. 7 with parameters μ=150, σ=50, v₁=150 km/h.

When orthogonal radio resource pools are used by each side of the highway, the relative velocity (within each radio resource pool) is distributed simply as

$${f}_{r}^{( 1 )} ( r \vert {v}_{1} ) = \frac{1}{\sqrt{2 {πσ}^{2}}} {e}^{- \frac{{( r + {v}_{1} - μ ) )}^{2}}{2 {σ}^{2}}}$$

The probability p can be written as follows

$$p = \frac{1}{{F}_{s} ( θ )} {\int }_{0}^{min ( θ , η )} {f}_{s} ( s ) P ( {max}_{0 \leq t \leq T} s ( t ) < η \vert s < η , s , v ) ds$$

where
initial (t=0) signal strength (S-RSSI), with pdf ƒₛ(s) and cdg Fₛ(s)
highest S-RSSI among all resources reported to higher layers (ψ×100% of total number of resources N), obtained by solving Fₛ(s)=ψ
P(max_{0≤t≤T}s(t)<η, s, v) is the probability that the received signal strength (S-RSSI) s(t) in a selected/reserved resource will stay below a threshold value η within the resource reselection period T, given an initial signal strength s<η and given that the sensing UE is moving with velocity v.

This probability can be found analytically (to be published). The result is shown in FIG. 8.

At low densities (up to 100 UEs/km, for N=500 candidate resources), the probability p is essentially one, regardless of whether both sides of the highway use the same radio resource pool or not. However, as the density grows (or the number of candidate resources N shrinks), it becomes increasingly likely that a UE on the opposite side of the highway will get close enough to the sensing UE within the resource reselection period to make the signal strength observed in the selected radio resource higher than the threshold. On the other hand, when opposite sides use orthogonal radio resource pools, the significantly lower relative velocities within each pool prevent this effect from occurring until much higher densities.

In particular, for T=1.0 s (corresponding to the 3GPP standard), the probability p using the proposed method is essentially one up to 1000 UEs/km. Without the proposed method, the probability p falls from 1 to 0.5 between 200 and 400 UEs/km. Beyond this density, only half of the selected resources will maintain a good quality within the resource reselection period.

While the invention has been illustrated and described in detail in the drawings and the foregoing description, such illustration and description are to be considered illustrative or exemplary and not restrictive. The invention is not limited to the disclosed embodiments. Such modifications may involve other features, which are already known in the art and may be used instead of or in addition to features already described herein.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

### REFERENCES

1 sidelink communication device

2 sidelink communication device

3 sidelink communication device

10 sidelink communication device

12 processor

14 communication interface

16 physical motion detection device

20 sidelink communication device

30 sidelink communication device

40 network management entity

41 wireless link

42 wireless link

43 wireless link

44 wireless link

45 wireless link

101 physical motion parameter (directional arrow)

102 physical motion parameter (directional arrow)

103 physical motion parameter (directional arrow)

104 physical motion parameter (directional arrow)

110 radio resource pool utilization sequence

201 physical motion parameter (directional arrow)

202 physical motion parameter(directional arrow)

203 physical motion parameter(directional arrow)

204 physical motion parameter (directional arrow)

211 slow lane

212 fast lane

213 fast lane

214 slow lane

What is claimed is:

1. A sidelink communication device comprising:
at least one processor; and
a non-transitory computer-readable storage medium coupled to the at least one processor and storing programming instructions for execution by the at least one processor, wherein the programming instructions instruct the at least one processor to:
select a radio resource pool from a plurality of radio resource pools based on a physical motion parameter of the sidelink communication device; and
communicate with another sidelink communication device using one or more radio resources of the selected radio resource pool.

2. The sidelink communication device of claim 1, wherein the programming instructions further instruct the at least one processor to:
measure the physical motion parameter;
receive the physical motion parameter from another sidelink communication device or a network management entity;
derive the physical motion parameter based on information measured by the sidelink communication device; or
derive the physical motion parameter based on information received from another sidelink communication device or a network management entity,

3. The sidelink communication device of claim 1, wherein the physical motion parameter is based on a velocity vector, in particular a magnitude or a direction of the velocity vector, of the sidelink communication device in a given frame of reference.

4. The sidelink communication device of claim 1, wherein the physical motion parameter is an index pointing to an element of a lookup table, wherein the element corresponds to a possible velocity vector of the sidelink communication device in a given frame of reference.

5. The sidelink communication device of claim 1, wherein the programming instructions further instruct the at least one processor to:
select the radio resource pool based on radio resource pool configuration information, wherein the radio resource pool configuration information comprises a correspondence of one or more possible physical motion parameters to one or more radio resource pools.

6. The sidelink communication device of claim 1, wherein the programming instructions further instruct the at least one processor to:
determine a flow identity based on the physical motion parameter and flow configuration information, wherein the flow configuration information comprises a correspondence of one or more possible physical motion parameters to one or more flow identities.

7. The sidelink communication device of the claim 1, wherein the programming instructions further instruct the at least one processor to:
select the radio resource pool based on a flow identity and radio resource pool configuration information, wherein the radio resource pool configuration information comprises a correspondence of one or more flow identities to one or more radio resource pools.

8. The sidelink communication device of claim 1, wherein the programming instructions further instruct the at least one processor to:
receive flow configuration information or radio resource pool configuration information from a network management entity.

9. The sidelink communication device of claim 1, comprising at least one of:
preconfigured flow configuration information, comprising a correspondence of one or more possible physical motion parameters to one or more flow identities;
preconfigured radio resource pool configuration information, comprising a correspondence of one or more flow identities to one or more radio resource pools; or
preconfigured radio resource pool configuration information, comprising a correspondence of one or more possible physical motion parameters to one or more radio resource pools.

10. The sidelink communication device of claim 1, wherein the programming instructions further instruct the at least one processor to:
select the radio resource pool based on a measurement of observed traffic load in one or more radio resource pools, in particular a Channel Busy Ratio (CBR) measurement, performed by the sidelink communication device.

11. A method comprising:
selecting a radio resource pool from a plurality of radio resource pools based on a physical motion parameter of a sidelink communication device; and
communicating with another sidelink communication device using one or more radio resources of the selected radio resource pool.

12. The method of claim 11, comprising:
determining a flow identity based on the physical motion parameter of the sidelink communication device; and
selecting the radio resource pool based on the determined flow identity.

13. The method of claim 11, wherein the physical motion parameter is based on a velocity vector, in particular a magnitude or a direction of the velocity vector, of the sidelink communication device in a given frame of reference.

14. A network management entity, comprising:
at least one processor; and
a non-transitory computer-readable storage medium coupled to the at least one processor and storing programming instructions for execution by the at least one processor, wherein the programming instructions instruct the at least one processor to:
generate radio resource pool configuration information, wherein the radio resource pool configuration information comprises a correspondence of one or more possible physical motion parameters to one or more radio resource pools or a correspondence of one or more flow identities to one or more radio resource pools; and
transmit the radio resource pool configuration information to one or more sidelink communication devices.

15. The network management entity of claim 14, wherein the correspondence of the one or more possible physical motion parameters to the one or more radio resource pools and the correspondence of the one or more flow identities to the one or more radio resource pools is determined based on a measurement of observed traffic load in one or more radio resource pools, in particular a Channel Busy Ratio (CBR) measurement, performed by one or more sidelink communication devices.

16. The network management entity of claim 4, wherein the programming instructions further instruct the at least one processor to:
generate flow configuration information, wherein the flow configuration information comprises a correspondence of one or more possible physical motion parameters to one or more flow identities; and
transmit the flow configuration information to the one or more sidelink communication devices.

17. The network management entity of claim 14, wherein at least one of the possible physical motion parameters is based on a velocity vector, in particular a magnitude or a direction of the velocity vector, in a given frame of reference.

18. The network management entity of claim 14, wherein the programming instructions further instruct the at least one processor to:
derive one or more of the possible physical motion parameters from one or more position reports received from one or more sidelink communication devices.

19. The network management entity of claim 14, wherein the programming instructions further instruct the at least one processor to:
generate the radio resource pool configuration information based on one or more of: a number of sidelink communication devices associated with a flow identity or a physical motion parameter, or a measurement of traffic demand of one or more sidelink communication devices associated with the flow identity or the physical motion parameter.
